(19) United States
(12) Patent Application Publication
(10) Pub. No.: US 2007/0239607 A1
(43) Pub. Date: Oct. 11, 2007

(54) Media Playback System

(76) Inventor: James O. Brabble, Chocowinity, NC (US)

Correspondence Address: ADVANTIA LAW GROUP, 9035 SOUTH 1300 EAST, SUITE 200, SANDY, UT, 84094, US

(21) Appl. No.: 11/277,983

(22) Filed: Mar. 30, 2006

(51) Int. Cl. H04L 9/00

(52) U.S. Cl. 705/51

(57) ABSTRACT

A novel media content reproduction device at least includes: a card reader adapted to engage with and read the contents of a flash memory card having prerecorded media content stored therein; user input adapted to receive reproduction control commands from a user; audio reproducer adapted to reproduce audio information stored on the media card; visual reproducer adapted to reproduce and display visual information; and control coupled to the user input and to the audio and visual reproducers, the control adapted to control the operation of the media content reproduction device.

### BACKGROUND OF THE INVENTION

1. Field of the Invention

The present invention generally relates to audio reproduction devices and systems.

2. Description of the Related Art

There are many solid state memory playback devices marketed which require a user to download or copy media content into internal memory or onto a memory card such as a Secure Data (SD) card. Prior art compact disc (CD) players allow a user to play pre-recorded CDs without the need for downloading music from the Internet or recording from other sources. However, CD players are now larger than desirable for some users. Additionally, moving parts and the tendency for CDs to become scratched or marred, lend CD player operation to dysfunction at times.

Newer solid state memory devices eliminate some of the problems associated with CD players, but typically require Internet downloading. Therefore, such devices do not allow full enjoyment for those who do not have access to a computer and the Internet, or those who are technophobes or technically challenged.

It is therefore desirable, but non-existent in the prior art, to provide a media playback device, system and method which can reproduce digital media content without the aforementioned drawbacks.

### SUMMARY OF THE INVENTION

The present invention has been developed in response to the present state of the art, and in particular, in response to the problems and needs in the art that have not yet been filly solved. Accordingly, the present invention has been developed to provide a novel media content reproduction device that at least includes: a card reader adapted to engage with and read the contents of a flash memory card having prerecorded media content stored therein; user input adapted to receive reproduction control commands from a user; audio reproducer adapted to reproduce audio information stored on the media card; visual reproducer adapted to reproduce and display visual information; and control coupled to the user input and to the audio and visual reproducers, the control adapted to control the operation of the media content reproduction device.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 contains an isometric view of the present-inventive media playback device; and

FIG. 2 contains a schematic block diagram of the present-inventive media playback system.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment.

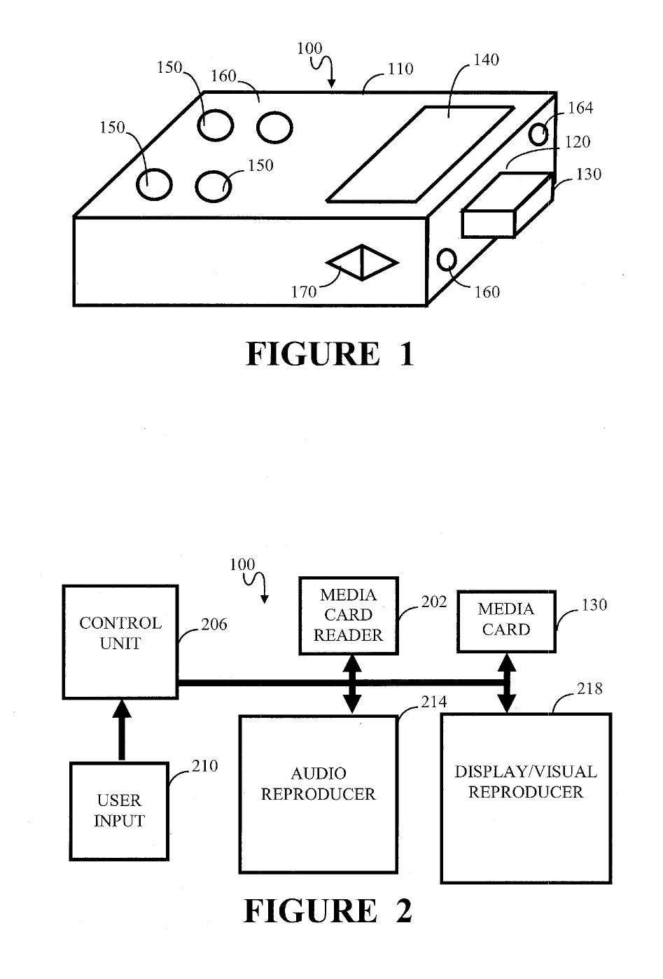

The present-inventive media playback device 100 is shown in FIG. 1. As described in the “SUMMARY” section above, the playback device 100 accepts a flash memory media card 130 with prerecorded audio visual programs via a card reader/port 120. The program content to be reproduced by the playback device 100 may be all audio, or a combination of audio and visual programming.

In the preferred embodiment, the media memory card 130 is designed to be purchased or ordered and received with the desired content thereon, without the need of the user to further record or download files. Media card delivery methods include retail outlets, kiosks, and mail order, to name just some of the methods.

The audio signal from the program is reproduced for listening at an audio jack 160, although other audio transducers such as a loudspeaker can be used. The visual inform is displayed on the display 140. During operation of the playback device, the display 140 can display a visual signal stored on the media card 130. The display 140 also displays control information input by the user via user input keys 150. The display can also reproduce metadata associated with the stored programs.

In the preferred embodiment, volume control keys 170 control the volume of the reproduced audio signal.

The reproduced media content includes music, music with information such as metadata, music and still images, video and others, including combinations of the aforementioned.

As an additional feature, the playback device includes a microphone jack 164 capable of receiving an audio signal from an external source. Such external audio signals include radio and television (audio) signals from radio and television receivers, and others. The aforementioned audio signals can be recorded onto the media card 130 as separate programs upon the user activating the appropriate keys 150.

A schematic block diagram of the playback device and system 100 is shown in FIG. 2. As can be seen, a pre-recorded media card 130 is electronically connected to a card reader device 202. The operation of the playback device is controlled by a control unit 206, which connects to the major components.

A user input 210 allows a user to input control commands. An audio reproducer 214 reproduces the program content at the direction of the control unit. A visual reproducer (or display) 218 reproduces visual information.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is expected that there could be numerous variations of the design of this invention.

Finally, it is envisioned that the components of the device may be constructed of a variety of materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A media content reproduction device comprising:
a card reader adapted to engage with and read the contents of a flash memory card having prerecorded media content stored therein;
user input adapted to receive reproduction control commands from a user;
audio reproducer adapted to reproduce audio information stored on said media card;
visual reproducer adapted to reproduce and display visual information; and
control coupled to said user input and to said audio and visual reproducers, said control adapted to control the operation of said media content reproduction device.

2. The device of claim 1, wherein said audio information comprises music files.

3. The device of claim 2, wherein said music files comprise songs.

4. The device of claim 2, wherein said visual information comprises metadata regarding said audio files.

5. The device of claim 1, wherein said visual information comprises still a, images.

6. The device of claim 1, wherein said visual information comprises video content.

7. A media content reproduction device consisting essentially of:
a card reader adapted to engage with and read the contents of a flash memory card having prerecorded media content stored therein;
user input adapted to receive reproduction control commands from a user;
audio reproducer adapted to reproduce audio information stored on said media card;
visual reproducer adapted to reproduce and display visual information; and
control coupled to said user input and to said audio and visual reproducers, said control adapted to control the operation of said media content reproduction device.

8. The device of claim 7, wherein said audio information consists essentially of music files.

9. The device of claim 8, wherein said music files consists essentially of songs.

10. The device of claim 8, wherein said visual information consists essentially of metadata regarding said audio files.

11. The device of claim 7, wherein said visual information consists essentially of still images.

12. The device of claim 7, wherein said visual information consists essentially of video content.

13. A media content reproduction device consisting of:
a card reader adapted to engage with and read the contents of a flash memory card having prerecorded media content stored therein;
user input adapted to receive reproduction control commands from a user;
audio reproducer adapted to reproduce audio information stored on said media card;
visual reproducer adapted to reproduce and display visual information; and
control coupled to said user input and to said audio and visual reproducers, said control adapted to control the operation of said media content reproduction device.

14. The device of claim 13, wherein said audio information consists of music files.

15. The device of claim 14, wherein said music files consists of songs.

16. The device of claim 14, wherein said visual information consists of metadata regarding said audio files.

17. The device of claim 13, wherein said visual information consists of still images.

18. The device of claim 13, wherein said visual information consists of video content.

19. The device of claim 1, further comprising a microphone jack adapted to receive a recordable audio signal from an external source;
wherein said device is further adapted to record said audio signal on said flash memory card.

20. The device of claim 13, further consisting of a microphone jack adapted to receive a recordable audio signal from an external source;
wherein said device is further adapted to record said audio signal on said flash memory card.
